(19) United States
(12) Patent Application Publication
(10) Pub. No.: US 2018/0062801 A1
(43) Pub. Date: Mar. 1, 2018

(54) TECHNIQUES FOR WIRELESS COMMUNICATIONS IN COORDINATED MULTI-POINT OPERATION

(71) Applicant: QUALCOMM Incorporated, San Diego, CA (US)

(72) Inventors: Xiaoxia ZHANG, San Diego, CA (US); Taesang Yoo, Riverside, CA (US); Jing Sun, San Diego, CA (US); Juan Montojo, San Diego, CA (US); Siddhartha Mallik, San Diego, CA (US)

(21) Appl. No.: 15/464,731

(22) Filed: Mar. 21, 2017

Related U.S. Application Data
(60) Provisional application No. 62/379,100, filed on Aug. 24, 2016.

(51) Int. Cl. H04L 5/00; H04L 27/26

(52) U.S. Cl. CPC H04L 5/0035; H04L 27/2605; H04L 5/0048

(57) ABSTRACT

Various aspects described herein relate to techniques for communications in a coordinated multi-point (CoMP) wireless communications system. In an aspect, a method of wireless communications may include transmitting, by a user equipment (UE), reference signal (RS) measurements for forming a CoMP cluster, receiving, at the UE from at least a base station in the CoMP cluster, a message including information of at least a first cyclic prefix (CP) length for a first uplink transmission, wherein at least the first CP length for the first uplink transmission is different from a second CP length used for a second uplink transmission, and transmitting, by the UE, the first uplink transmission using at least the first CP length. The techniques described herein may apply to different communications technologies, including 5th Generation (5G) New Radio (NR) communications technology.

### CROSS-REFERENCE TO RELATED APPLICATION

This application claims the benefit of U.S. Provisional Application Ser. No. 62/379,100, entitled “TECHNIQUES FOR SOUNDING REFERENCE SIGNALS AND DOWNLINK TRANSMISSIONS IN COORDINATED MULTI-POINT OPERATION” and filed on Aug. 24, 2016, which is expressly incorporated by reference herein in its entirety.

### BACKGROUND

Aspects of the present disclosure relate generally to wireless communications systems, and more particularly, to transmissions and receptions in a coordinated multi-point (CoMP) wireless communications system (e.g., a 5G New Radio system).

Wireless communications systems are widely deployed to provide various telecommunication services such as telephony, video, data, messaging, and broadcasts. Typical wireless communications systems may employ multiple-access technologies capable of supporting communication with multiple users by sharing available system resources (e.g., time, frequency, power, and/or spectrum). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA).

These multiple access technologies have been adopted in various telecommunication standards to provide a common protocol that enables different wireless devices to communicate on a municipal, national, regional, and even global level. An example telecommunication standard is Long Term Evolution (LTE) or LTE-Advanced (LTE-A). In LTE-A network, coordinated multi-point (CoMP) operation is introduced to improve network performance, for example, at cell edges. In CoMP a number of transmit (TX) points provide coordinated transmission(s) in the downlink, a number of receive (RX) points provide coordinated reception(s) in the uplink, and the coordination may be done for both homogenous networks as well as heterogeneous networks. However, although newer multiple access systems, such as an LTE or LTE-A system, deliver faster data throughput than older technologies, such increased downlink rates have triggered a greater demand for higher-bandwidth content, such as high-resolution graphics and video, for use on or with mobile devices. As such, demand for bandwidth, higher data rates, better transmission quality as well as better spectrum utilization, and lower latency on wireless communications systems continues to increase.

The 5th Generation (5G) New Radio (NR) communications technology, used in a wide range of spectrum, is envisaged to expand and support diverse usage scenarios and applications with respect to current mobile network generations. In an aspect, 5G NR communications technology may include, for example: enhanced mobile broadband (eMBB) addressing human-centric use cases for access to multimedia content, services and data; ultra-reliable low-latency communications (URLLC) with strict requirements, especially in terms of latency and reliability; and massive machine type communications (mMTC), which may allow a very large number of connected devices and transmission of a relatively low volume of non-delay-sensitive information. In an aspect, for varied deployments and/or applications, 5G NR communications technology may use enhanced subframe design and structure, and efficient waveform modulation and coding schemes. In addition, as the demand for mobile broadband access continues to increase, there exists a need for further improvements in 5G communications technology and beyond. Preferably, these improvements should be applicable to other multi-access technologies and the telecommunication standards that employ these technologies.

Accordingly, new or improved approaches may be desirable to improve throughputs (e.g., for cell-edge users), transmission quality and reliability, as well as spectrum utilization, in order to satisfy consumer demand and improve user experience in wireless communications (e.g., 5G NR).

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its purpose is to present some concepts of one or more aspects in a simplified form as a prelude to the more detailed description that is presented later.

According to an example, a method related to uplink transmissions in a coordinated multi-point (CoMP) wireless communications system is provided. The method includes transmitting, by a user equipment (UE), reference signal (RS) measurements for forming a CoMP cluster, receiving, at the UE from at least a base station in the CoMP cluster, a message including information of at least a first cyclic prefix (CP) length for a first uplink transmission, wherein at least the first CP length for the first uplink transmission is different from a second CP length used for a second uplink transmission, and transmitting, by the UE, the first uplink transmission using at least the first CP length.

In an aspect, a method related to downlink transmissions in a CoMP wireless communications system is provided. The method includes transmitting, by a UE, RS measurements for forming a CoMP cluster, receiving, at the UE from at least a base station in the CoMP cluster, a message including information of at least a CP length for a downlink (DL) CoMP transmission, wherein at least the CP length for the DL CoMP transmission is different from the CP length for a single cell transmission, and receiving, at the UE, the DL CoMP transmission with at least the CP length.

In another aspect, an apparatus for wireless communications is provided that includes a transmitter, a receiver, and one or more processors communicatively coupled with the transmitter and the receiver. The one or more processors are configured to perform the operations of methods described herein. In an aspect, for example, the apparatus for wireless communications may include a transmitter, a receiver, and at least one processor communicatively coupled to the transmitter and the receiver, wherein the at least one processor is configured to perform RS measurements; transmit, via the transmitter, the RS measurements for forming a CoMP cluster; receive, via the receiver from at least a base station in the CoMP cluster, a message including information of at least a first CP length for a first uplink transmission, wherein at least the first CP length for the first uplink transmission is different from a second CP length used for a second uplink transmission; and transmit, via the transmitter, the first uplink transmission using at least the first CP length.

In an aspect, an apparatus for wireless communications is provided that includes a transmitter, a receiver, and one or more processors communicatively coupled with the transmitter and the receiver. The one or more processors are configured to perform the operations of methods described herein. In an aspect, for example, the apparatus for wireless communications may include a transmitter, a receiver, and at least one processor communicatively coupled to the transmitter and the receiver, wherein the at least one processor is configured to: perform RS measurements; transmit, via the transmitter, the RS measurements for forming a CoMP cluster; receive, via the receiver from at least a base station in the CoMP cluster, a message including information of at least a CP length for a DL CoMP transmission, wherein the CP length for the DL CoMP transmission is different from the CP length for a single cell transmission; and receive, via the receiver, the DL CoMP transmission with at least the CP length.

In another aspect, an apparatus for wireless communications is provided that includes means for performing the operations of methods described herein. In yet another aspect, a computer-readable medium (e.g., a non-transitory computer-readable storage medium) is provided including code executable by one or more processors to perform the operations of methods described herein.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

In order to facilitate a fuller understanding of aspects described herein, reference is now made to the accompanying drawings, in which like elements are referenced with like numerals. These drawings should not be construed as limiting the present disclosure, but are intended to be illustrative only.

FIG. 1 is a block diagram of an example communications network including at least two network entities in communication with a user equipment (UE) configured to perform sounding reference signals (SRS) management and CoMP transmissions, according to one or more of the presently described aspects.

FIG. 2A is an example frame structure for downlink (DL) transmissions with different cyclic prefix (CP) lengths and different demodulation reference signal (DMRS) symbols.

FIG. 2B is a diagram of an example communications network with SRS transmissions, according to one or more of the presently described aspects.

FIGS. 2C and 2D are diagrams of two examples of communications networks with DL CoMP transmissions, according to one or more of the presently described aspects.

FIGS. 2E and 2F are diagrams of two examples of a communications network using SRS power control, according to one or more of the presently described aspects.

FIG. 3 is a flow diagram of a first example method of uplink (UL) CoMP communications using different CP lengths, according to one or more of the presently described aspects.

FIG. 4 is a flow diagram of a first example method of DL CoMP communications using different CP lengths, according to one or more of the presently described aspects.

FIG. 5 is a flow diagram of a first example method of SRS power control, according to one or more of the presently described aspects.

FIG. 6 is a flow diagram of a second example method of UL CoMP communications using different CP lengths, according to one or more of the presently described aspects.

FIG. 7 is a flow diagram of a second example method of DL CoMP communications using different CP lengths, according to one or more of the presently described aspects.

FIG. 8 is a flow diagram of a second example method of SRS power control, according to one or more of the presently described aspects.

### DETAILED DESCRIPTION

In a wireless communications network (e.g., an LTE network, or a 5G NR network), coordinated multi-point (CoMP) operations may be used to improve system or network reliability and performance, for example, for cell-edge users. In some implementations using CoMP operations, multiple base stations (e.g., eNBs) within a CoMP cluster may obtain downlink (DL) and/or uplink (UL) channel information for a user equipment (UE) based on UL sounding reference signals (SRS). Different base stations may suffer timing difference and/or propagation delay difference when obtaining channel information (e.g., DL or UL channel state information) from the UE. As such, new or improved radio frame or subframe structure design with dynamic cyclic prefix (CP) lengths for UL (e.g., SRS) and/or DL CoMP communications may be desired. In addition, new or improved DL/UL (e.g., SRS) power control schemes used for CoMP communications may be needed in a wireless communications network (e.g., a 5G NR network).

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more aspects, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), and floppy disk where disks usually reproduce data magnetically, while discs reproduce data optically with lasers. Combinations of the above should also be included within the scope of computer-readable media.

Described herein are various aspects related to a wireless communications system (e.g., a 5G NR system), in particular, sounding reference signals (SRS) and downlink transmissions in coordinated multi-point (CoMP) operations for wireless communications. In an aspect, in a CoMP operation, multiple base stations (e.g., eNBs) within a CoMP cluster may obtain downlink (DL) and/or uplink (UL) channel information for a user equipment (UE) based on SRS. In an aspect, the SRS may use a longer (or extended) cyclic prefix (CP) with a long or extended CP length compared to other UL transmissions depending on a CoMP set. In another aspect, power control of the SRS may be based on a serving link or based on one or more communication links to the base stations (e.g., eNBs or a subset of eNBs) in the CoMP set. Similarly, the DL/UL data transmissions may use a longer CP with a long or extended CP length depending on the CoMP set and the co-scheduled UEs. UE may use the CP length(s) indicated in a broadcast channel (e.g., a Physical Broadcast Channel (PBCH)) to decode a Radio Resource Control (RRC) configuration message. The RRC may configure a default CP type or length for a data channel (e.g., a Physical Downlink Shared Channel (PDSCH)) depending on the CoMP set, and use dynamic CP signaling from one transmission to another. In an aspect, with different CP lengths, the subframe structure may be different. In another aspect, with different CP lengths, the Demodulation Reference Signal (DMRS) design may also be different.

In some examples, a normal or short CP length may have a duration of about 4.65.2 microseconds (e.g., 4.7 microseconds), and a long or extended CP length may have a duration of about 16.616.7 microseconds (e.g., 16.67 microseconds). In some aspects, the ranges of a CP length may be from ¼ to 1/32 of a symbol period. Short CP lengths may be associated with small cells and long or extended CP lengths may be associated with macro cells where the delay spread of a channel is large (e.g., when relays may be used).

In an aspect, channel reciprocity may be used in a time-division duplexing (TDD) network for base stations (e.g., eNBs) to obtain DL channel state information from UL SRS transmissions without relying on intensive feedback from UEs.

In an aspect, a network may be divided into multiple CoMP clusters and may apply centralized scheduling within each CoMP cluster. In some examples, a CoMP cluster may include one or more base stations (e.g., eNBs) and/or one or more cells, and a UE may be connected to a CoMP cluster when its serving cell belongs to the cluster. In CoMP, joint processing (JP) may be used in DL and/or UL and multiple base stations (e.g., eNBs) within a CoMP cluster may need to obtain the DL and/or UL channel information (e.g., channel state information (CSI), channel quality information (CQI)) for a same UE. In some examples, the multiple base stations (e.g., eNBs) may be able to receive SRS from both serving and non-serving UEs. In an aspect, CoMP is operating in the unit of multiple points, and the multiple points participating in a CoMP is considered as a CoMP set. In some examples, SRS may be intended for partial or all cells in a CoMP set.

In another aspect, different base stations (e.g., eNBs) within the CoMP set may have slight timing difference and/or propagation delay difference. In some examples, the delay spread of an uplink transmission (e.g., SRS) for a non-serving UE (e.g., a UE is far away from the cell) may be larger than the CP length designed for single-cell UL transmissions. In an aspect, one or more single-cell transmissions may not be processed jointly by the receiving base stations or without CoMP joint processing. In some examples, the delay spread between data transmitted from multiple cells in a CoMP cluster could be larger than the CP length designed for single-cell DL or UL transmissions.

In an aspect, one or more base stations (e.g., eNBs) may form a CoMP cluster for each UE based on UE's reference signal (RS) measurements, for example, reference signal received power (RSRP) measurement, reference signal received quality (RSRQ) measurement, or received signal strength indicator (RSSI).

In some aspects, the path loss difference and potential timing difference between multiple base stations (e.g., eNBs) in a CoMP cluster may dictate the CP length for UL (e.g., SRS) and/or DL CoMP transmissions. In some examples, UL transmissions (e.g., SRS) may use one or more different CP lengths compared to other UL channels. For example, a base station (e.g., eNB) may configure the CP length for SRS along with other parameters such as virtual cell identification (ID). In some examples, UL or DL CoMP transmissions may use one or more different CP lengths compared to single-cell transmissions. In an example, the base station (e.g., eNB) may further indicate the default CP length used for DL and/or UL CoMP transmissions.

In some examples, a UL transmission discussed above may be a UL SRS or a transmission over Physical Uplink Shared Channel (PUSCH). In an aspect, joint processing may be performed for UL SRS, PUSCH, or other UL channels that use different CP lengths. For example, a first UL/DL channel or signal going through the joint processing may require different CP length(s) compared with a second UL/DL channel or signal without joint processing. In some aspects of DL CoMP communications, multiple base stations (e.g., in a CoMP cluster) may transmit jointly to a UE, and because of different propagation delays or timing offsets, an extended or long CP length may be used for the UE to be able to coherently process the signals transmitted by the multiple base stations. In an example, multiple base stations may process jointly on each UE's signal for better receiver processing, and with different propagation delay(s) and timing offset(s), an extended or long CP may be used for the multiple base stations to process the UE's signal(s) coherently.

In an aspect, based on SRS receptions and co-scheduled UEs, a base station (e.g., an eNB) within a CoMP cluster may determine whether or not to participate in a joint transmission (JT). In an example, the base station (e.g., eNB) may further indicate the CP length for DL or UL CoMP transmissions. In some examples, the CP length may be dynamic.

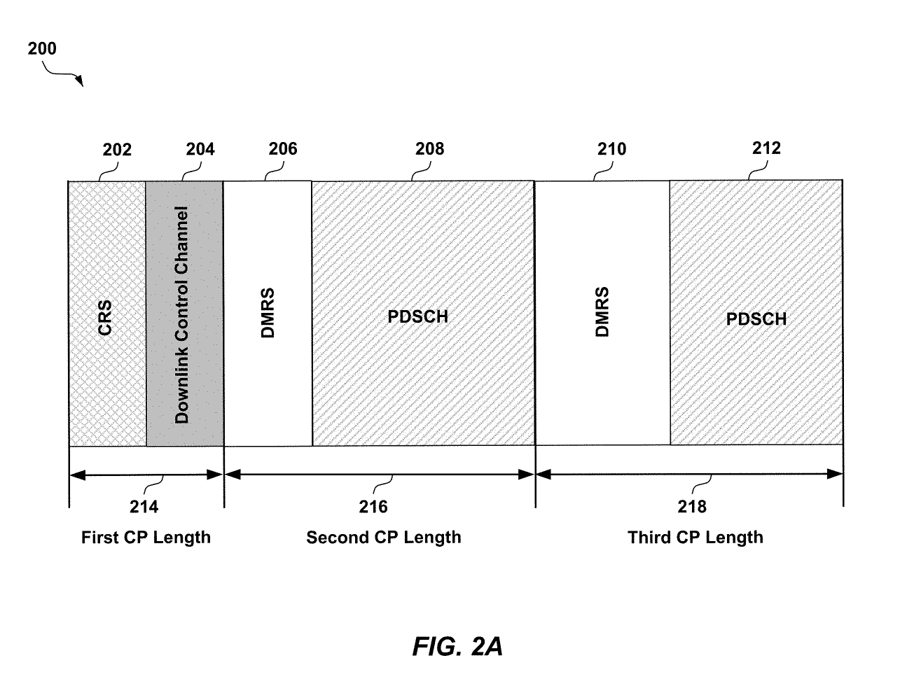

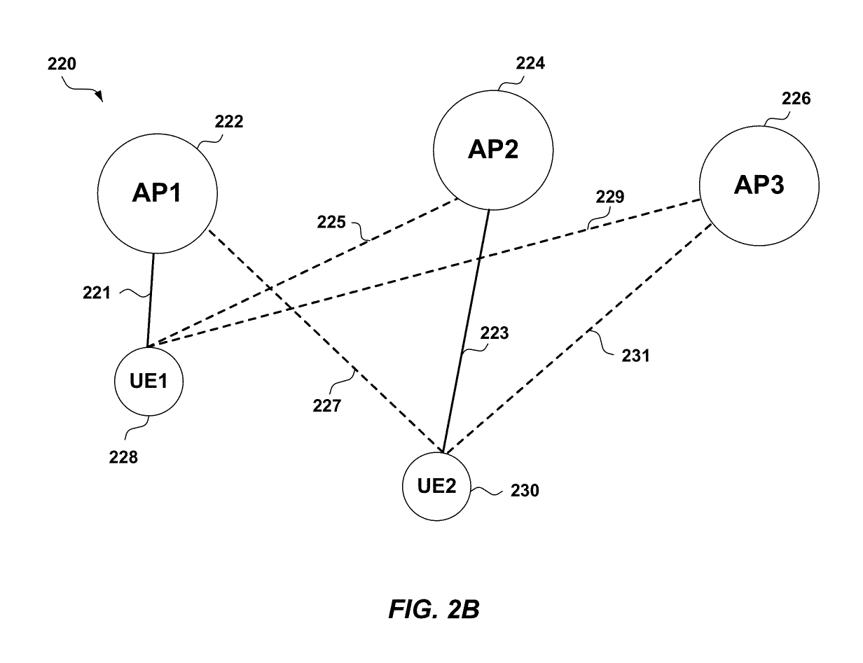

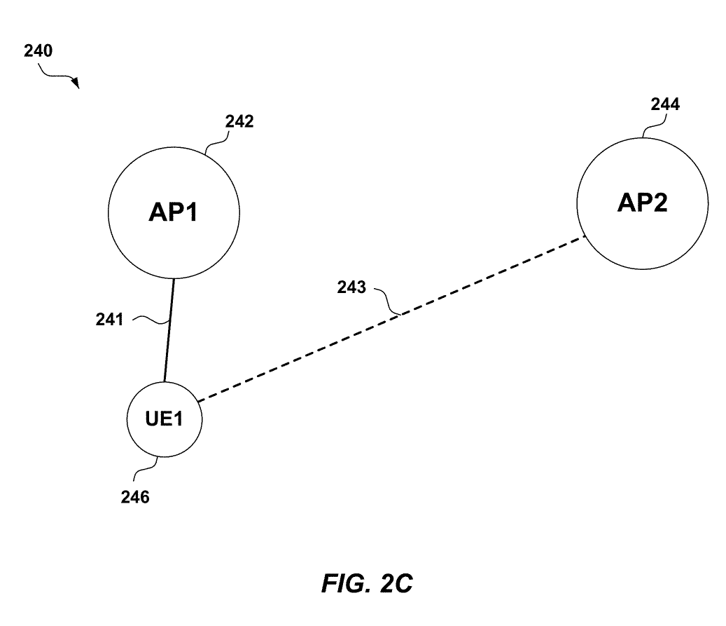

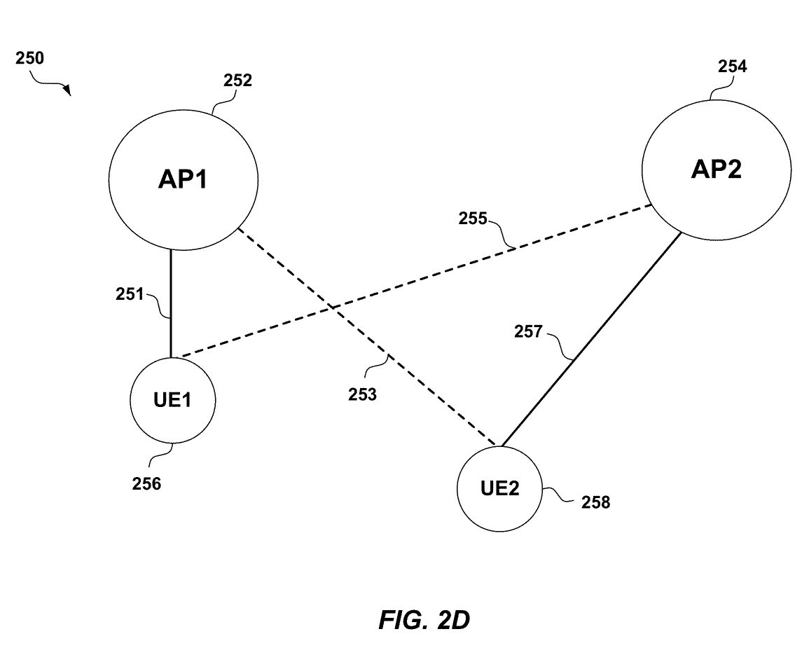

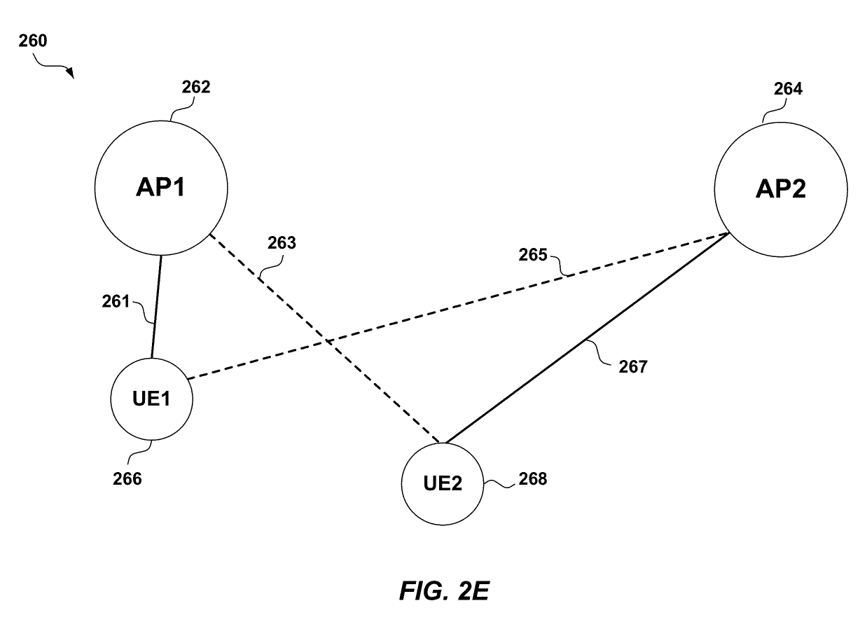

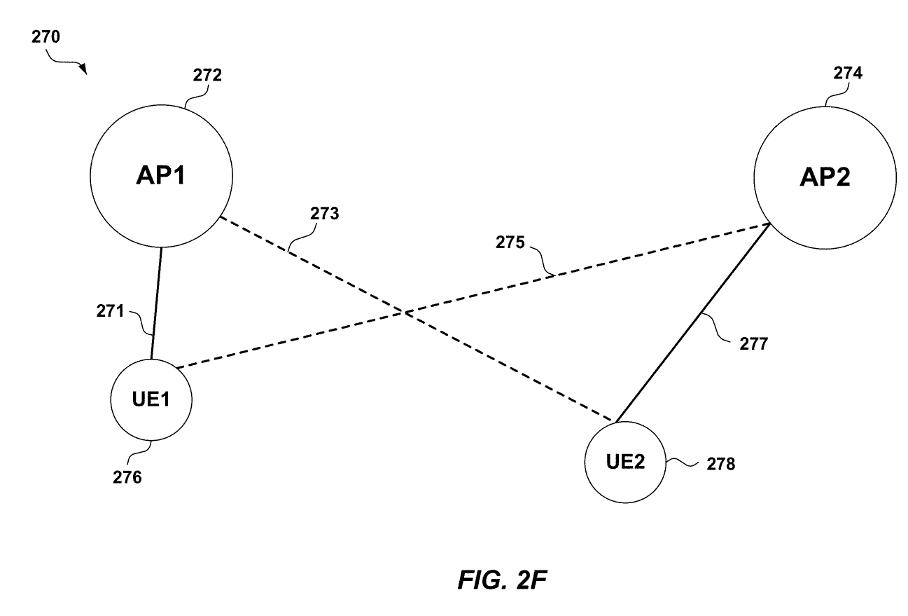

In some examples related to DL CoMP transmissions, in an aspect, the transmissions of a cell-specific reference signal (CRS) preamble and a control channel (e.g., physical downlink control channel (PDCCH)) or control information may use/follow the CP length signaled or indicated in a broadcast channel such as a PBCH. In another aspect, the CP length for the first subframe may follow the default CP length configured by RRC messages/configuration. In an aspect, subsequent subframes (e.g., the second subframe and/or the third subframe) may follow the CP length indicated in DL grant(s). In some aspects, the DMRS on subframes with different CP lengths may have different radio frame/subframe structures, and these radio frame/subframe structures may include the structures used in legacy networks/systems or 5G NR communication networks/systems. For example, in a four-by-four (4×4) MIMO system, DMRS on subframes with a short CP may use two (2) symbols while a long CP may use four (4) symbols, as shown later in an example of a data channel (e.g., PDSCH) transmission with different CP lengths and reference signal (e.g., DMRS) structures (e.g., in FIG. 2A). In some examples related to UL CoMP transmissions, the CP length(s) may be configured by RRC messages/configurations or indicated in UL grants.

In some aspects, a UL (e.g., SRS) power control scheme used for CoMP communications (and/or 5G NR) may be similar to the UL (e.g., SRS) power control scheme used in legacy systems (e.g., an LTE system). In some examples, the UL (e.g., SRS) power control is based on serving links between serving UEs and their serving cell(s), and each cell may perform the power control on SRS transmissions of its serving UEs independently. In an aspect, for example, SRS power control may target similar received power on each sub-carrier from both serving UEs at the cell center and serving UEs at the cell edge. In some examples, SRS power control may not consider the impact to non-serving UEs or non-serving base stations (e.g., eNBs). In some examples, a UE at/with good geometry may use less power for SRS transmission, and the UE' SRS penetration to non-serving base stations (e.g., eNBs) is reduced compared to UEs at the cell edge. In some aspects, on a receiver of a base station (e.g., an eNB), there may be large power difference from serving and non-serving UEs, which may cause interference on adjacent carriers and/or impact Automatic Gain Control (AGC). In some examples, to minimize the issue with SRS power difference, different transmit (TX) antennas of a UE may use a same SRS symbol for signal transmission.

In some aspects, in addition to the serving links, UL (e.g., SRS) power control schemes used for CoMP communications (e.g., in a 5G NR system) may be based on the link(s) (e.g., the weakest link) between UEs and base station(s) (e.g., eNBs) other than the serving base station(s) in a CoMP cluster. In other words, the SRS power control may consider both the serving links and non-serving links that reach non-serving base station(s) and/or non-serving UE(s). In some examples, a high geometry UE may transmit with high SRS power to reach its non-serving base station(s). In some aspects, on a receiver of a base station (e.g., an eNB), there may be large power difference or imbalance (e.g., 20 dB or larger) from serving UEs, or from serving and non-serving UEs, which may cause interference on adjacent carriers and/or impact Automatic Gain Control (AGC). In some examples, to minimize the issue with SRS power difference, different transmit (TX) antennas of a UE may use a same SRS symbol for signal transmission. In some aspects, the network may control SRS power based on a subset of one or more cells in a CoMP set, or depends on the numbers of base stations in the CoMP cluster, to have better trade-off of SRS penetration and/or SRS power difference. In some aspects, the SRS power control may take into account the signal interference or power leakage from other links (serving or non-serving links).

In some aspects, to minimize the issue with SRS power distribution (e.g., SRS power imbalance/difference), the SRS power control may consider even power distribution for links connected with at least a subset of the base stations in a CoMP cluster. In some examples, if the power level of a link is too low and may generate a huge SRS power imbalance/difference, the link with low power may be dropped.

In some examples, time division multiplexing (TDM) may be used for SRS power control in CoMP communications (and/or 5G NR). In this case, links for serving base station(s)/UE(s) and/or non-serving base station(s)/US(s) may use different time slots for communication.

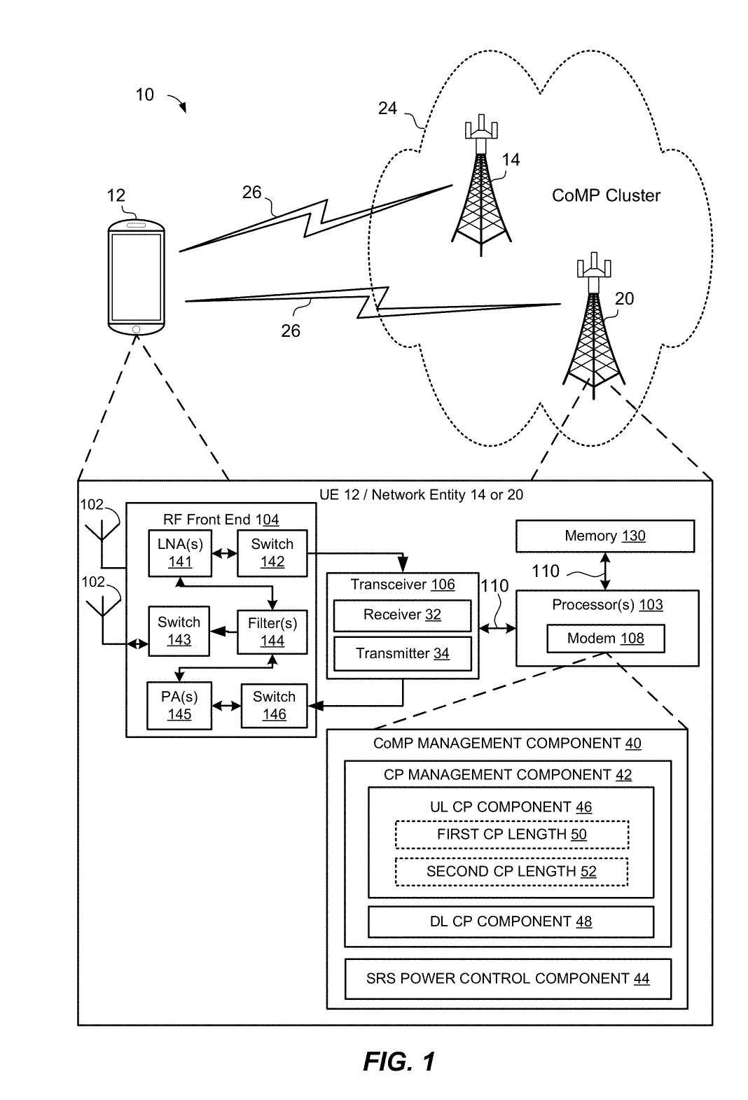

Each of the aspects described above are performed or implemented in connection with FIGS. 1-8, which are described in more detail below.

Referring to FIG. 1, in an aspect, a wireless communications system 10 includes at least one UE 12 in communication coverage of at least one network entity 14 or network entity 20 (e.g., base station or eNB, or a cell thereof, in a coordinated multi-point (CoMP) cluster/set 24). UE 12 may communicate with a network via the network entity 14 or network entity 20. In some aspects, multiple UEs including UE 12 may be in communication coverage with one or more network entities, including network entity 14 and network entity 20, both of which are in the CoMP cluster/set 24. In an aspect, the network entity 14 or network entity 20 may be a base station such an eNodeB/eNB in a long term evolution (LTE) network. Although various aspects are described in relation to a UMTS, LTE, or 5G NR networks, similar principles may be applied in other wireless wide area networks (WWAN). The wireless network may employ a scheme where multiple base stations may transmit on a channel. In an example, UE 12 may transmit and/or receive wireless communications to and/or from network entity 14 and/or network entity 20. For example, the UE 12 may be actively communicating with network entity 14 and/or network entity 20.

In some aspects, UE 12 may also be referred to by those skilled in the art (as well as interchangeably herein) as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a terminal, a user agent, a mobile client, a client, or some other suitable terminology. A UE 12 may be a cellular phone, a personal digital assistant (PDA), a wireless modem, a wireless communications device, a handheld device, a tablet computer, a laptop computer, a cordless phone, a wireless local loop (WLL) station, a global positioning system (GPS) device, a multimedia device, a video device, a digital audio player (e.g., MP3 player), a camera, a game console, a wearable computing device (e.g., a smart-watch, smart-glasses, a health or fitness tracker, etc.), an appliance, a sensor, a vehicle communication system, a medical device, a vending machine, a device for the Internet-of-Things, or any other similar functioning device. Additionally, network entity 14 or network entity 20 may be a macrocell, picocell, femtocell, relay, Node B, mobile Node B, small cell box, UE (e.g., communicating in peer-to-peer or ad-hoc mode with UE 12), or substantially any type of component that can communicate with UE 12 to provide wireless network access at the UE 12.

According to the present aspects, the UE 12 and/or network entity 14/20 may include one or more processors 103 and a memory 130 that may operate in combination with a CoMP management component 40 to control a CP management component 42 a UL CP component 46, a DL CP component 48, and/or a SRS power control component 44 for performing sounding reference signals (SRS) management and/or UL/DL CoMP transmissions. For example, the CoMP management component 40 may perform UL/DL communications management (e.g., SRS/PUSCH transmissions, SRS power control), participate (or not) in joint transmission/reception, and/or participate in operations related to determining, choosing, or indicating CP length(s) for UL/DL CoMP transmissions. In some aspects, the UL CP component 46 may include, indicate, or determine/calculate a first CP length 50, and/or a second CP length 52. In some examples, the first CP length 50 and the second CP length 52 may be same or different, and the first CP length 50 or the second CP length 52 may be a normal CP length or an extended CP length, where the extended CP length is longer in time duration than the normal CP length.

In an aspect, the term “component” as used herein may be one of the parts that make up a system, may be hardware, firmware, and/or software, and may be divided into other components. The CoMP management component 40 may be communicatively coupled to a transceiver 106, which may include a receiver 32 for receiving and processing RF signals and a transmitter 34 for processing and transmitting RF signals. The CoMP management component 40 may include the CP management component 42 (and its subcomponents, UL CP component 46 and DL CP component 48) and/or the SRS power control component 44 for performing UL/DL CoMP transmissions, UL/DL CP selection/indication, and/or SRS power management. The processor 103 may be coupled to the transceiver 106 and memory 130 via at least one bus 110.

The receiver 32 may include hardware, firmware, and/or software code executable by a processor for receiving data, the code comprising instructions and being stored in a memory (e.g., computer-readable medium). The receiver 32 may be, for example, a radio frequency (RF) receiver. In an aspect, the receiver 32 may receive signals transmitted by UE 12 or network entity 14/20. The receiver 32 may obtain measurements of the signals. For example, the receiver 32 may determine Ec/Io, SNR, etc.

The transmitter 34 may include hardware, firmware, and/or software code executable by a processor for transmitting data, the code comprising instructions and being stored in a memory (e.g., computer-readable medium). The transmitter 34 may be, for example, a RF transmitter.

In an aspect, the one or more processors 103 can include a modem 108 that uses one or more modem processors. The various functions related to the CoMP management component 40 may be included in modem 108 and/or processors 103 and, in an aspect, can be executed by a single processor, while in other aspects, different ones of the functions may be executed by a combination of two or more different processors. For example, in an aspect, the one or more processors 103 may include any one or any combination of a modem processor, or a baseband processor, or a digital signal processor, or a transmit processor, or a transceiver processor associated with transceiver 106. In particular, the one or more processors 103 may implement components included in the CoMP management component 40, including the CP management component 42, the UL CP component 46, the DL CP component 48, and/or the SRS power control component 44.

The CoMP management component 40, CP management component 42, UL CP component 46, DL CP component 48, and/or the SRS power control component 44 may include hardware, firmware, and/or software code executable by a processor for performing UL/DL CoMP transmissions, UL/DL CP selection/indication, and/or SRS power management. For example, the hardware may include, for example, a hardware accelerator, or specialized processor.

Moreover, in an aspect, UE 12 and/or network entity 14/20 may include RF front end 104 and transceiver 106 for receiving and transmitting radio transmissions, for example, wireless communications 26. For example, transceiver 106 may transmit or receive a signal that includes a pilot signal (e.g., common pilot channel (CPICH)). The transceiver 106 may measure the received pilot signal in order to determine signal quality and for providing feedback to the network entity 14. For example, transceiver 106 may communicate with modem 108 to transmit messages generated by CoMP management component 40 and to receive messages and forward them to CoMP management component 40.

RF front end 104 may be connected to one or more antennas 102 and can include one or more low-noise amplifiers (LNAs) 141, one or more switches 142, 143, one or more power amplifiers (PAs) 145, and one or more filters 144 for transmitting and receiving RF signals. In an aspect, components of RF front end 104 can connect with transceiver 106. Transceiver 106 may connect to one or more modems 108 and processor 103.

In an aspect, LNA 141 can amplify a received signal at a desired output level. In an aspect, each LNA 141 may have a specified minimum and maximum gain values. In an aspect, RF front end 104 may use one or more switches 142, 143 to select a particular LNA 141 and its specified gain value based on a desired gain value for a particular application. In an aspect, the RF front end 104 may provide measurements (e.g., Ec/Io) and/or applied gain values to the CoMP management component 40.

Further, for example, one or more PA(s) 145 may be used by RF front end 104 to amplify a signal for an RF output at a desired output power level. In an aspect, each PA 145 may have a specified minimum and maximum gain values. In an aspect, RF front end 104 may use one or more switches 143, 146 to select a particular PA 145 and its specified gain value based on a desired gain value for a particular application.

Also, for example, one or more filters 144 can be used by RF front end 104 to filter a received signal to obtain an input RF signal. Similarly, in an aspect, for example, a respective filter 144 can be used to filter an output from a respective PA 145 to produce an output signal for transmission. In an aspect, each filter 144 can be connected to a specific LNA 141 and/or PA 145. In an aspect, RF front end 104 can use one or more switches 142, 143, 146 to select a transmit or receive path using a specified filter 144, LNA, 141, and/or PA 145, based on a configuration as specified by transceiver 106 and/or processor 103.

Transceiver 106 may be configured to transmit and receive wireless signals through antenna 102 via RF front end 104. In an aspect, transceiver may be tuned to operate at specified frequencies such that UE 12 can communicate with, for example, network entity 14 or network entity 20. In an aspect, for example, modem 108 can configure transceiver 106 to operate at a specified frequency and power level based on the UE configuration of the UE 12 and communication protocol used by modem 108.

In an aspect, modem 108 can be a multiband-multimode modem, which can process digital data and communicate with transceiver 106 such that the digital data is sent and received using transceiver 106. In an aspect, modem 108 can be multiband and be configured to support multiple frequency bands for a specific communications protocol. In an aspect, modem 108 can be multimode and be configured to support multiple operating networks and communications protocols. In an aspect, modem 108 can control one or more components of UE 12 or network entity 14/20 (e.g., RF front end 104, transceiver 106) to enable transmission and/or reception of signals based on a specified modem configuration. In an aspect, the modem configuration can be based on the mode of the modem and the frequency band in use. In another aspect, the modem configuration can be based on UE configuration information associated with UE 12 as provided by the network during cell selection and/or cell reselection.

UE 12, network entity 14, or network entity 20 may further include memory 130, such as for storing data used herein and/or local versions of applications or CoMP management component 40 and/or one or more of its subcomponents being executed by processor 103. Memory 130 can include any type of computer-readable medium usable by a computer or processor 103, such as random access memory (RAM), read only memory (ROM), tapes, magnetic discs, optical discs, volatile memory, non-volatile memory, and any combination thereof. In an aspect, for example, memory 130 may be a computer-readable storage medium that stores one or more computer-executable codes defining CoMP management component 40 and/or one or more of its subcomponents, and/or data associated therewith, when UE 12 and/or network entity 14/20 is operating processor 103 to execute CoMP management component 40 and/or one or more of its subcomponents. In another aspect, for example, memory 130 may be a non-transitory computer-readable storage medium.

Referring to FIG. 2A, an example frame/subframe structure 200 for DL (e.g., PDSCH) transmissions with dynamic or different cyclic prefix (CP) lengths and/or DMRS symbols is provided. In an aspect, the CP length for a DL transmission may be configured dynamically. For example, the CP length for a DL CoMP transmission may be configured as the same CP length used for a single cell transmission, or may be configured as a different CP length from the CP length used for a single-cell transmission. In some examples, similar frame/subframe structure and/or scheme may be applicable to UL transmissions.

In another example, the CP length for a DL transmission may be configured dynamically in a frame-by-frame or a subframe-by-subframe basis. As discussed above, in some aspects, the transmission of a CRS preamble, and a DL control channel (e.g., physical downlink control channel (PDCCH)) or control information may use/follow the CP signaled or indicated in a broadcast channel (e.g., a PBCH). For example, as shown in FIG. 2A, a subframe 214 may include a CRS preamble 202 and a DL control channel (e.g., PDCCH) 204, and the subframe 214 may have a first CP length which is indicated in a PBCH. In an aspect, the CP length for a first subframe may follow the default CP length configured by RRC messages or configurations. For example, a subframe 216 may include a DMRS 206 with two symbols and a data channel 208 (e.g., PDSCH), and the subframe 216 may have a second CP length which is indicated in or configured by RRC. In another aspect, subsequent subframes (e.g., the second subframe, the third subframe, etc.) may follow the CP length indicated in DL grant(s) in earlier subframes (e.g., cross subframe scheduling) to allow the UE 12 to process the DL grant(s) and/or to adjust the CP length accordingly. For example, a subframe 218 may include a DMRS 210 with four symbols and a data channel 212 (e.g., PDSCH), and the subframe 218 may have a third CP length which is indicated in a DL grant. In some examples of UL communications, the CP length for a UL transmission may be configured dynamically in a frame-by-frame or a subframe-by-subframe basis based on one or more UL grants.

In some aspects, the DMRS on subframes with different CP lengths may have different radio frame/subframe structures, and these radio frame/subframe structures may include the structures used in legacy networks/systems or 5G NR communications networks/systems. For example, in a four-by-four (4×4) MIMO system, DMRS on subframe(s) with a normal or short CP length may use 2 symbols (e.g., the DMRS 206) while DMRS on subframe(s) with a long or extended CP length may use 4 symbols (e.g., the DMRS 210).

In an aspect of FIGS. 2B-2F, solid lines, dashed lines, or both may be used for communications between a UE and a base station (or an access point (AP)). In some examples, a solid line means that UE is served by that base station while a dashed line stands for a communication channel between a UE and a non-serving base station. In an aspect, for example, an uplink transmission (e.g., SRS) may or may not be monitored or received by a non-serving base station, depending on the path loss difference between a serving base station and a non-serving base station.

Referring to FIG. 2B, an example communications network with SRS transmissions is provided. In an aspect, a first base station or access point 222 (AP1) and a second base station or access point 224 (AP2) are in a first CoMP cluster for a first UE 228 (UE1), while AP1, AP2, and a third base station or access point 226 (AP3) are in a second CoMP cluster for a second UE 230 (UE2). In this example, UE1 uses normal CP length for SRS transmissions (e.g., via links 221 and 225) and targets for receptions on AP1 and AP2 (e.g., via links 221 and 225), and UE2 uses long/extended CP length for SRS transmissions (e.g., via links 227, 223, and 231) and targets for receptions on AP1, AP2, and AP3 (e.g., via links 227, 223, and 231). In an aspect, the timing difference and/or propagation delay between AP1 and AP2 allow UE1 to stay with short/normal CP length for SRS transmissions. In another aspect, UE2 may use long/extended CP length for SRS transmissions due to the timing difference and/or propagation delay among AP1, AP2, and AP3. In an aspect, when the network intends to schedule UE1 and UE2 on a same set of frequency resources at the same time, AP1, AP2, and AP3 may perform joint scheduling or coordinated scheduling (CS) for both UE1 and UE2. In another aspect, if AP3 is not able to receive SRS transmissions from UE1 with normal CP length, AP3 may treat a link between AP3 and UE1 (e.g., link 229) to be negligible, for example, setting a related parameter to zero, and/or not listening or hearing from UE1 in the future or at a certain time period.

Referring to FIG. 2C, an example communications network with DL CoMP transmissions is provided. In this example, a first base station or access point 242 (API) and a second base station or access point 244 (AP2) are in a same CoMP cluster for a UE 246 (UE1). In some aspects, the fading on a listen-before-talk (LBT) burst indicates that the power level of DL channel transmissions from AP1 to UE1 (e.g., via link 241) is much stronger than the power level of DL channel transmissions from AP2 to UE1 (e.g., via link 243). In this case, due to a weak communication link (e.g., link 243), AP2 may not join the data transmissions (e.g., not participate in JT) for UE1, and AP1 may use a normal CP length for DL CoMP transmissions to UE1 (e.g., via link 241). In an aspect, the CP length may be indicated in a DL grant. In another aspect, the first couple of (e.g., N) transmission time intervals (TTIs), subframes, or symbols may use the default CP length (a normal CP length or a long CP length) to allow UE to process the DL grant. In some examples, if different UEs use different frequencies and are frequency division multiplexed (FDMed) on a same carrier, the UEs may either use a same CP length or the base station (e.g., eNB) may leave some guard tones to reduce inter-carrier interference (ICI). In some examples of UL communications, similarly to DL CoMP transmissions, a UL CoMP transmission from a UE may use different CP lengths depending on the base stations involved in the receiver (e.g., at the base stations) processing and the CP length(s) may be indicated in one or more UL grants.

Referring to FIG. 2D, another example communications network with DL CoMP transmissions is provided. In this example related to DL CoMP transmissions, a first base station or access point 252 (AP1) and a second base station or access point 254 (AP2) are in a same CoMP cluster for a UE 256 (UE1). In an aspect, AP1 and AP2 may communicate with each other via beamforming. In some aspects, the fading on a LBT burst may indicate that the power level of DL channel transmissions from AP1 to UE1 (e.g., via link 251) is much stronger than the power level of DL channel transmissions from AP2 to UE1 (e.g., via link 255). In an aspect, AP1 and/or AP2 may observe that there is no big difference of SRS power level/strength from a UE 258 (UE2) (e.g., via links 253 and 257), and UE2 may operate at the same time and/or use the same frequency as UE1. In an aspect, AP2 may transmit data to UE2 without constraint on the interference caused by the communications with UE1. In another aspect, AP1 transmits data to UE1 (e.g., via link 251) subject to its interference to UE2 may be minimized or limited. In some examples, the CP length used by AP1 for communications with UE1 may depend on both UE1 and UE2. For example, in case UE2 uses a long (or extended) CP length for transmissions, UE1 may be consistent with UE2 and may also use the long CP length. In other words, the CP used for communicating from AP1 to UE1 (e.g., via link 251) and to UE2 (e.g., via link 253) may be consistent or same. In some examples, AP2 may not participate in the joint transmission(s) for UE1 (e.g., link 255 is weak or negligible).

Referring to FIG. 2E, an example of an SRS power control scheme used for CoMP communications (and/or 5G NR) is provided. In this example, the SRS power control scheme may be similar to the power control schemes used in legacy systems (e.g., an LTE system). In some examples, the SRS power control is based on serving links between serving UEs and their serving cell(s). In this example, a UE 266 (UE1) and a UE 268 (UE2) are both served by a base station or access point 262 (AP1). The link between UE1 and AP1 (e.g., link 261), and the link between UE2 and AP1 (e.g., link 263) may have similar receiving power on AP1. However, a base station or access point 264 (AP2) may hear or receive SRS transmissions from UE2 (e.g., via link 267) with much better signal strength (or higher signal power) than from UE1 (e.g., via link 265). As such, at AP2, the received power of SRS transmissions from UE1 and UE2 may have big power difference.

Referring to FIG. 2F, another example of an SRS power control scheme used for CoMP communications (and/or 5G NR) is provided. In this example, the SRS power control scheme may consider both serving links and non-serving links that reach non-serving base station(s) and/or non-serving UE(s). In an example, a UE 276 (UE1) is served by a base station or access point 272 (AP1), and a UE 278 (UE2) is served by a base station or access point 274 (AP2). In an aspect, the SRS power control targets a certain received SRS power level on some weak links. For example, a non-serving link 273 between UE2 and API, and/or a non-serving link 275 between UE1 and AP2. This example may assume or imply that a serving link 271 between UE1 and AP1 is much stranger (e.g., 20 dB or more) than the non-serving link 273 between UE2 and AP1, and/or a serving link 277 between UE2 and AP2 is much stranger (e.g., 20 dB or more) than the non-serving link 275 between UE1 and AP2. As such, for example, at AP1 and/or AP2, the received SRS power level from UE1 and UE2 may have big difference.

While, for purposes of simplicity of explanation, the method is shown and described as a series of acts, it is to be understood and appreciated that the method (and further methods related thereto) is/are not limited by the order of acts, as some acts may, in accordance with one or more aspects, occur in different orders and/or concurrently with other acts from that shown and described herein. For example, it is to be appreciated that a method could alternatively be represented as a series of interrelated states or events, such as in a state diagram. Moreover, not all illustrated acts may be required to implement a method in accordance with one or more features described herein.

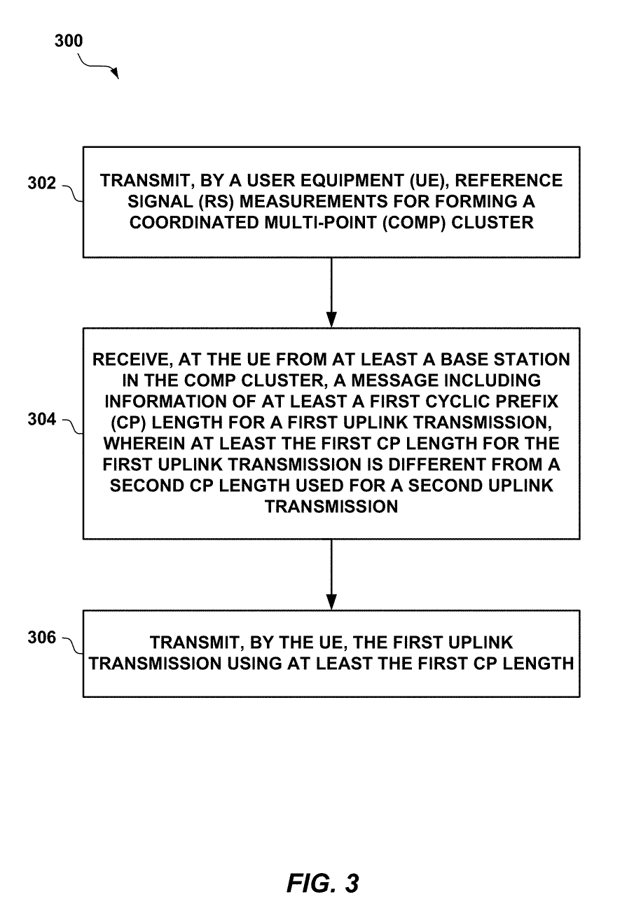

Referring to FIG. 3, in an operational aspect, a UE such as UE 12 (FIG. 1) may perform one or more aspects of a method 300 for UL management and communications. For example, one or more of the processors 103, the memory 130, the modem 108, the transceiver 106 (including the receiver 32 and/or the transmitter 34), the CoMP management component 40, and/or at least one of the sub-components of the CoMP management component 40 may be configured to perform one or more aspects of the method 300.

In an aspect, at block 302, the method 300 may include transmitting, by a user equipment (UE), reference signal (RS) measurements for forming a coordinated multi-point (CoMP) cluster. In an aspect, for example, the CoMP management component 40 (FIG. 1), e.g., in conjunction with one or more of the processors 103, the memory 130, the modem 108, and/or the transceiver 106, may generate and transmit the RS measurements, for example, reference signal received power (RSRP) measurement, reference signal received quality (RSRQ) measurement, or received signal strength indicator (RSSI) for forming a CoMP cluster.

In an aspect, at block 304, the method 300 may include receiving, at the UE from at least a base station in the CoMP cluster, a message including information of at least a first cyclic prefix (CP) length for a first uplink transmission, wherein at least the first CP length for the first uplink transmission is different from a second CP length used for a second uplink transmission. In an aspect, for example, the CoMP management component 40, the CP management component 42, and/or the UL CP component 46 (FIG. 1), e.g., in conjunction with one or more of the processors 103, the memory 130, the modem 108, and/or the transceiver 106, may receive a message including information of at least a CP length and manage the received CP length for a UL transmission. In some examples, the UL transmission may be an SRS or a physical uplink signal (e.g., a PUSCH). In some examples, the first uplink transmission is to be processed jointly at multiple base stations in the CoMP cluster or associated with CoMP joint processing, and the second uplink transmission is not to be processed jointly at multiple base stations in the CoMP cluster or not associated with CoMP joint processing.

In an aspect, at block 306, the method 300 may include transmitting, by the UE, the first uplink transmission using at least the first CP length. In an aspect, for example, the CoMP management component 40, the CP management component 42, and/or the UL CP component 46 (FIG. 1), e.g., in conjunction with one or more of the processors 103, the memory 130, the modem 108, and/or the transceiver 106, may perform UL transmissions based on the received CP length.

In another aspect of the method 300, at least the first CP length for the UL transmission is dynamically configured based on path loss difference or timing difference between the base station and another base station in the CoMP cluster.

In an aspect of the method 300, at least the first CP length is a normal CP length or an extended CP length, wherein the extended CP length is longer in time duration than the normal CP length.

In another aspect of the method 300, at least the first CP length for the UL transmission (e.g., an SRS or a PUSCH) is configured along with a virtual cell identification (ID) and/or other parameters. In an example, when the first uplink transmission is a physical uplink signal (e.g., PUSCH), at least the first CP length may be indicated in a UL grant or configured in a RRC message.

In an aspect of the method 300, the CoMP cluster may include at least the base station, and the UE is connected to the CoMP cluster when a serving cell of the UE belongs to the CoMP cluster.

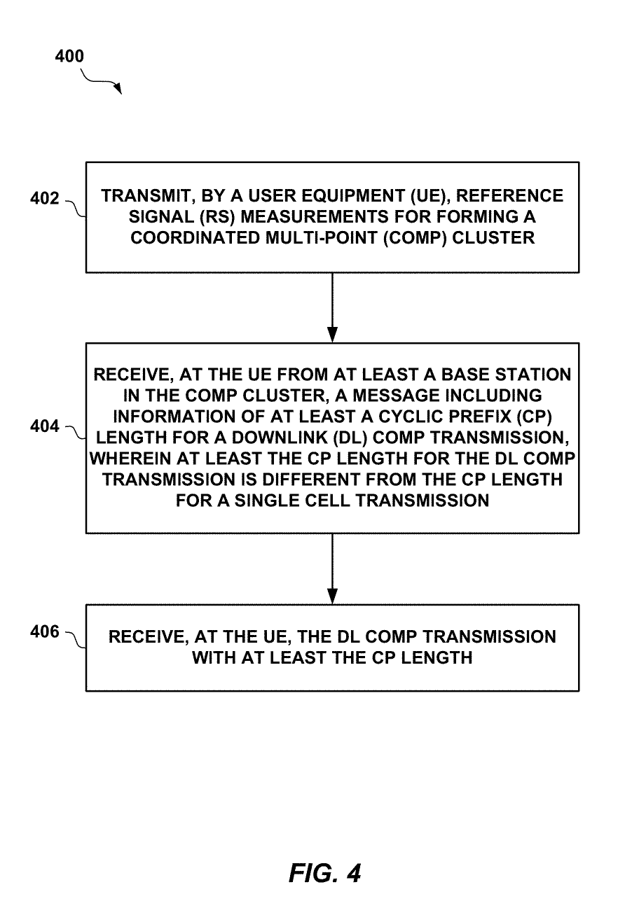

Referring to FIG. 4, in an operational aspect, a UE such as UE 12 (FIG. 1) may perform one or more aspects of a method 400 for DL CoMP transmissions. For example, one or more of the processors 103, the memory 130, the modem 108, the transceiver 106 (including the receiver 32 and/or the transmitter 34), the CoMP management component 40, or at least one of the sub-components of the CoMP management component 40 may be configured to perform aspects of the method 400.

In an aspect, at block 402, the method 400 may include transmitting, by a UE,

RS measurements for forming a CoMP cluster. In an aspect, for example, the CoMP management component 40 (FIG. 1), e.g., in conjunction with one or more of the processors 103, the memory 130, the modem 108, and/or the transceiver 106, may generate and transmit the RS measurements, for example, RSRP measurement, RSRQ measurement, or an RSSI for forming a CoMP cluster.

In an aspect, at block 404, the method 400 may include receiving, at the UE from at least a base station in the CoMP cluster, a message including information of at least a CP length for a DL CoMP transmission, wherein the CP length for the DL CoMP transmission is different from the CP length for a single cell transmission. In an aspect, for example, the CP management component 42 and/or the DL CP component 48, e.g., in conjunction with one or more of the processors 103, the memory 130, the modem 108, and/or the transceiver 106, may receive and identify the CP length for an upcoming DL CoMP transmission.

In an aspect, at block 406, the method 400 may include receiving, at the UE, the DL CoMP transmission with at least the CP length. In an aspect, for example, the CP management component 42 and/or the DL CP component 48 (FIG. 1), e.g., in conjunction with one or more of the processors 103, the memory 130, the modem 108, and/or the transceiver 106, may receive and identify the CP length for the DL CoMP transmission.

In another aspect, the method 400 may include receiving, at the UE, one or more DMRS symbols based on at least the CP length received and/or identified at block 404.

In another aspect of the method 400, at least the CP length is a normal CP length or an extended CP length, wherein the extended CP length is longer in time duration than the normal CP length.

In an aspect of the method 400, the message includes information of a default CP length for the DL CoMP transmission.

In another aspect of the method 400, the message is an RRC message.

In an aspect of the method 400, the message includes a DL grant, and the DL grant may include the information of at least the CP length.

In another aspect of the method 400, the message is received over a Physical Broadcast Channel (PBCH).

In an aspect of the method 400, the CoMP cluster includes at least the base station, and the UE is connected to the CoMP cluster when a serving cell of the UE belongs to the CoMP cluster.

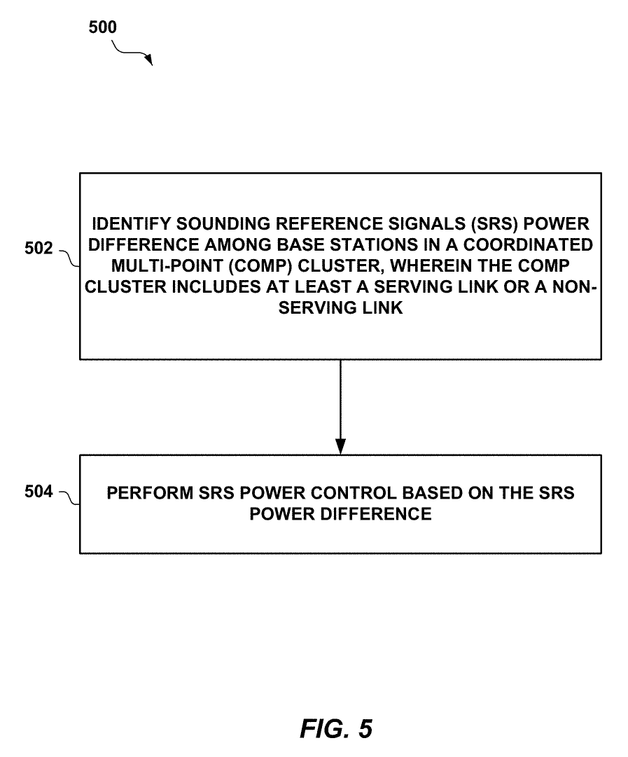

Referring to FIG. 5, in an operational aspect, a UE such as UE 12 (FIG. 1) may perform one or more aspects of a method 500 for SRS power control management. For example, one or more of the processors 103, the memory 130, the modem 108, the transceiver 106 (including the receiver 32 and/or the transmitter 34), the CoMP management component 40, or at least one of the sub-components of the CoMP management component 40 may be configured to perform aspects of the method 500.

In an aspect, at block 502, the method 500 may include identifying sounding reference signals (SRS) power difference among base stations in a coordinated multi-point (CoMP) cluster, wherein the CoMP cluster includes at least a serving link or a non-serving link. In an aspect, for example, the SRS power control component 44 (FIG. 1), e.g., in conjunction with one or more of the processors 103, the memory 130, the modem 108, may be configured to identify sounding SRS power difference among multiple base stations in a CoMP cluster.

In an aspect, at block 504, the method 500 may include performing SRS power control based on the SRS power difference. In an aspect, for example, the SRS power control component 44 (FIG. 1), e.g., in conjunction with one or more of the processors 103, the memory 130, the modem 108, and/or the transceiver 106, may be configured to perform SRS power control based on the identified or determined SRS power difference at block 502.

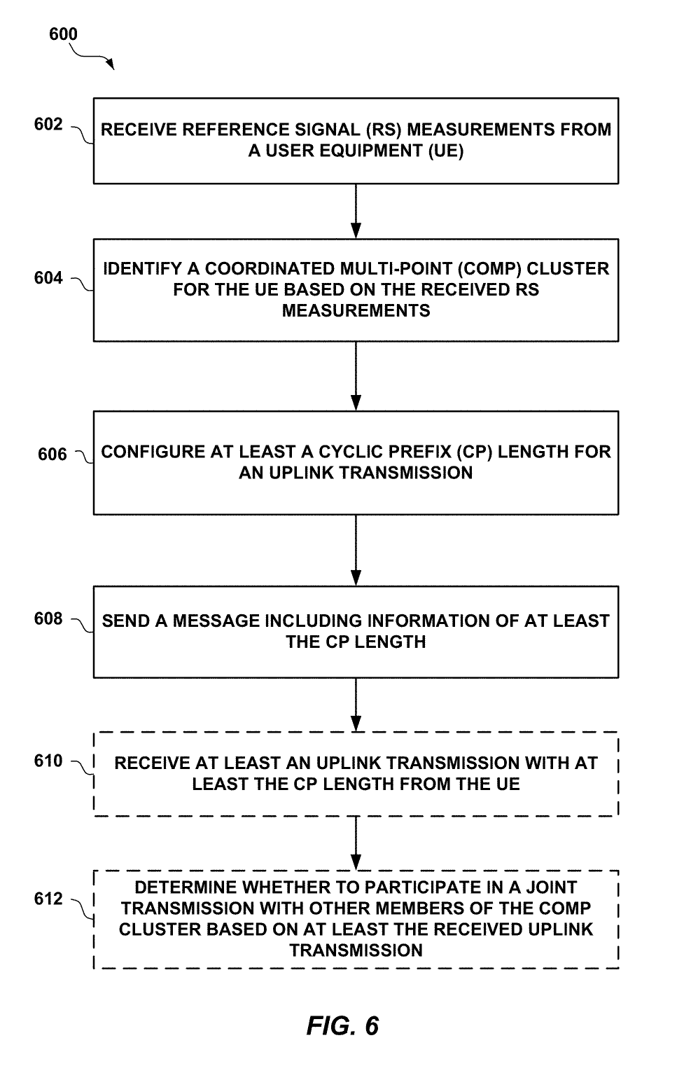

Referring to FIG. 6, in an operational aspect, a network entity such as network entity 14 or network entity 20 (FIG. 1) may perform one or more aspects of a method 600 for SRS transmissions. For example, one or more of the processors 103, the memory 130, the modem 108, the transceiver 106 (including the receiver 32 and/or the transmitter 34), the CoMP management component 40, or at least one of the sub-components of the CoMP management component 40 may be configured to perform aspects of the method 600.

In an aspect, at block 602, the method 600 may include receiving RS measurements from a UE. In an aspect, for example, the CoMP management component 40, e.g., in conjunction with one or more of the processors 103, the memory 130, the modem 108, and/or the transceiver 106, may be configured to receive RS measurements, for example, RSRP measurement, RSRQ measurement, or an RSSI from one or more UEs.

In an aspect, at block 604, the method 600 may include identifying a CoMP cluster for the UE based on the received RS measurements. In an aspect, for example, the CoMP management component 40, e.g., in conjunction with one or more of the processors 103, the memory 130, the modem 108, and/or the transceiver 106, may be configured to identify one or more CoMP clusters for each UE based on the received RS measurements at block 602.

In an aspect, at block 606, the method 600 may include configuring at least a CP length for a UL (e.g., an SRS or a PUSCH) transmission. In an aspect, the CP length for a UL transmission may be configured dynamically. For example, the CP length for a UL transmission may be configured as the same CP length (e.g., the second CP length 52) used for one or more UL transmissions without CoMP joint processing, or configured as a different CP length (e.g., the first CP length 50) from the CP length used for one or more UL transmissions without CoMP joint processing. In an aspect, for example, the CoMP management component 40, the CP management component 42, and/or the UL CP component 46 (e.g., including the first CP length 50 and/or the second CP length 52), e.g., in conjunction with one or more of the processors 103, the memory 130, the modem 108, and/or the transceiver 106, may configure or setup at least a CP length for the UL (e.g., an SRS or a PUSCH) transmission. In an example, the CoMP management component 40, the CP management component 42, and/or the UL CP component 46 may configure to provide a CP length that is same as or different from the CP length used for one or more UL transmissions/signals without CoMP joint processing.

In an aspect, at block 608, the method 600 may include sending a message including information of at least the CP length. In an aspect, for example, the CoMP management component 40, the CP management component 42, and/or the UL CP component 46, e.g., in conjunction with one or more of the processors 103, the memory 130, the modem 108, and/or the transceiver 106, may be configured to transmit or send a message to the UE including information of at least the CP length (e.g., the first CP length 50 or the second CP length 52).

In an aspect, at block 610, the method 600 may optionally include receiving at least a UL transmission (e.g., an SRS or a PUSCH) with at least the CP length from the UE. In an aspect, for example, the CoMP management component 40, the CP management component 42, and/or the UL CP component 46, e.g., in conjunction with one or more of the processors 103, the memory 130, the modem 108, and/or the transceiver 106, may be configured to receive UL transmission(s) (e.g., an SRS or a PUSCH) with the CP length (e.g., the first CP length 50 or the second CP length 52) from the UE.

In an aspect, at block 612, the method 600 may optionally include determining whether to participate in a joint transmission with other members of the CoMP cluster based on at least the received SRS. In an aspect, for example, the CoMP management component 40, e.g., in conjunction with one or more of the processors 103, the memory 130, the modem 108, and/or the transceiver 106, may be configured to determine whether to participate in a joint transmission with one or more members of the CoMP cluster based on at least the received SRS.

In another aspect of the method 600, at least the CP length (e.g., the first CP length 50 or the second CP length 52) for the UL transmission (e.g., an SRS or a PUSCH) is dynamically configured based on path loss difference or timing difference between the base station and another base station in the CoMP cluster.

In an aspect of the method 600, at least the CP length (e.g., the first CP length 50 or the second CP length 52) is a normal CP length or an extended CP length, wherein the extended CP length is longer in time duration than the normal CP length.

In another aspect of the method 600, at least the CP length (e.g., the first CP length 50 or the second CP length 52) for the UL transmission is configured along with a virtual cell ID and/or other parameters.

In an aspect of the method 600, the CoMP cluster may include one or more base stations, and the UE is connected to the CoMP cluster when a serving cell of the UE belongs to the CoMP cluster.

In another aspect, the method 600 may optionally include performing UL (e.g., SRS) power control based on at least a serving link (or a non-serving link) in the CoMP cluster with at least the UE, or based on at least a subset of cells in the CoMP cluster.

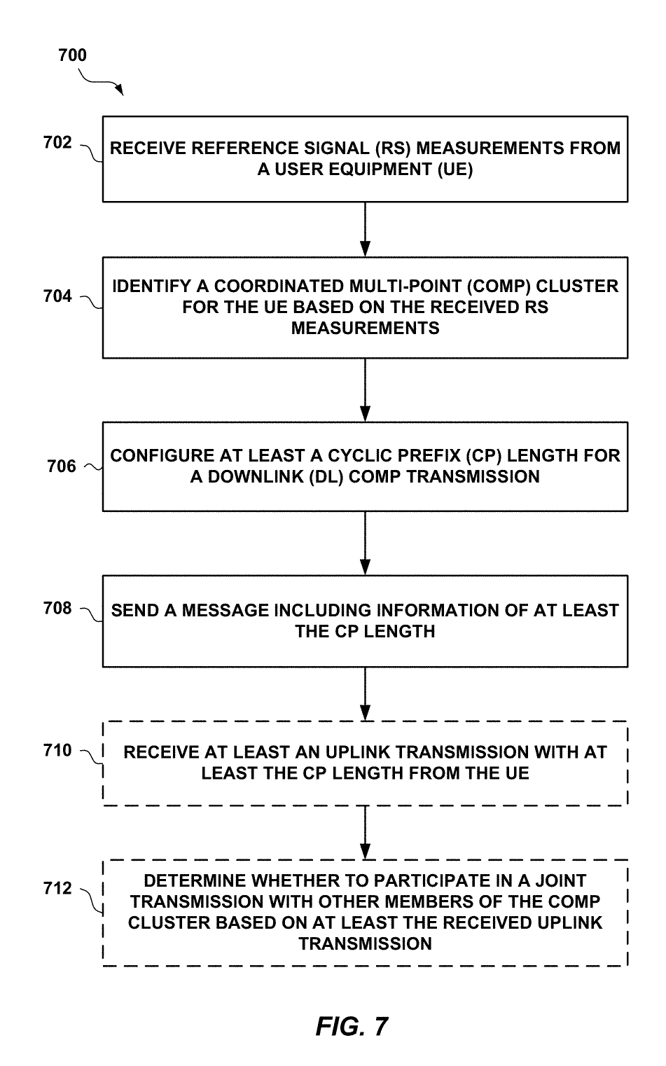

Referring to FIG. 7, in an operational aspect, a network entity such as network entity 14 or network entity 20 (FIG. 1) may perform one or more aspects of a method 700 related to DL CoMP transmissions. For example, one or more of the processors 103, the memory 130, the modem 108, the transceiver 106 (including the receiver 32 and/or the transmitter 34), the CoMP management component 40, or at least one of the sub-components of the CoMP management component 40 may be configured to perform aspects of the method 700.

In an aspect, at block 702, the method 700 may include receiving RS measurements from a UE. In an aspect, for example, the CoMP management component 40, e.g., in conjunction with one or more of the processors 103, the memory 130, the modem 108, and/or the transceiver 106, may be configured to receive RS measurements, for example, RSRP measurement, RSRQ measurement, or an RSSI from one or more UEs.

In an aspect, at block 704, the method 700 may include identifying a CoMP cluster for the UE based on the received RS measurements. In an aspect, for example, the CoMP management component 40, e.g., in conjunction with one or more of the processors 103, the memory 130, the modem 108, and/or the transceiver 106, may be configured to identify one or more CoMP clusters for each UE based on the received RS measurements at block 702.

In an aspect, at block 706, the method 700 may include configuring at least a CP length for a DL CoMP transmission. In an aspect, the CP length for a DL CoMP transmission may be configured dynamically. For example, the CP length for the DL CoMP transmission may be configured as the same CP length used for a single cell transmission, or may be configured as a different CP length from the CP length for a single cell transmission. In an aspect, for example, the CP management component 42 and/or the DL CP component 48, e.g., in conjunction with one or more of the processors 103, the memory 130, the modem 108, and/or the transceiver 106, may configure or setup a CP length for a DL CoMP transmission. In an example, the CP management component 42 and/or the DL CP component 48 may configure to provide a CP length for the DL CoMP transmission that is same as or different from the CP length used for a single cell transmission.

In an aspect, at block 708, the method 700 may include sending a message including information of at least the CP length. In an aspect, for example, the CoMP management component 40, the CP management component 42, and/or the DL CP component 48, e.g., in conjunction with one or more of the processors 103, the memory 130, the modem 108, and/or the transceiver 106, may be configured to transmit or send a message to the UE including information of at least the CP length.

In an aspect, at block 710, the method 700 may optionally include receiving at least a UL transmission (e.g., an SRS or a PUSCH) with at least the CP length from the UE. In an aspect, for example, the CoMP management component 40, the CP management component 42, e.g., in conjunction with one or more of the processors 103, the memory 130, the modem 108, and/or the transceiver 106, may be configured to receive UL transmission (e.g., an SRS or a PUSCH) with at least the CP length (e.g., the first CP length 50 or the second CP length 52) from the UE.

In an aspect, at block 712, the method 700 may optionally include determining whether to participate in a joint transmission with other members of the CoMP cluster based on at least the received UL transmission (e.g., an SRS or a PUSCH). In an aspect, for example, the CoMP management component 40, e.g., in conjunction with one or more of the processors 103, the memory 130, the modem 108, and/or the transceiver 106, may be configured to determine whether to participate in a joint transmission with one or more members of the CoMP cluster based on at least the received UL transmission.

In another aspect, the method 700 may optionally include sending DMRS symbols based on at least the CP length configured at block 706.

In another aspect of the method 700, at least the CP length is a normal CP length or an extended CP length, wherein the extended CP length is longer in time duration than the normal CP length.

In an aspect of the method 700, the message may include information of a default CP length for the DL CoMP transmission.

In another aspect of the method 700, the message may be an RRC message.

In an aspect of the method 700, the message may be or may include a DL grant, and the DL grant may include the information of at least the CP length.

In another aspect of the method 700, the message may be transmitted or sent over a PBCH.

In an aspect of the method 700, the CoMP cluster includes one or more base stations, and the UE is connected to the CoMP cluster when a serving cell of the UE belongs to the CoMP cluster.

In another aspect, the method 700 may optionally include performing UL (e.g., SRS) power control based on at least a serving link (or a non-serving link) in the CoMP cluster with at least the UE, or based on at least a subset of cells in the CoMP cluster.

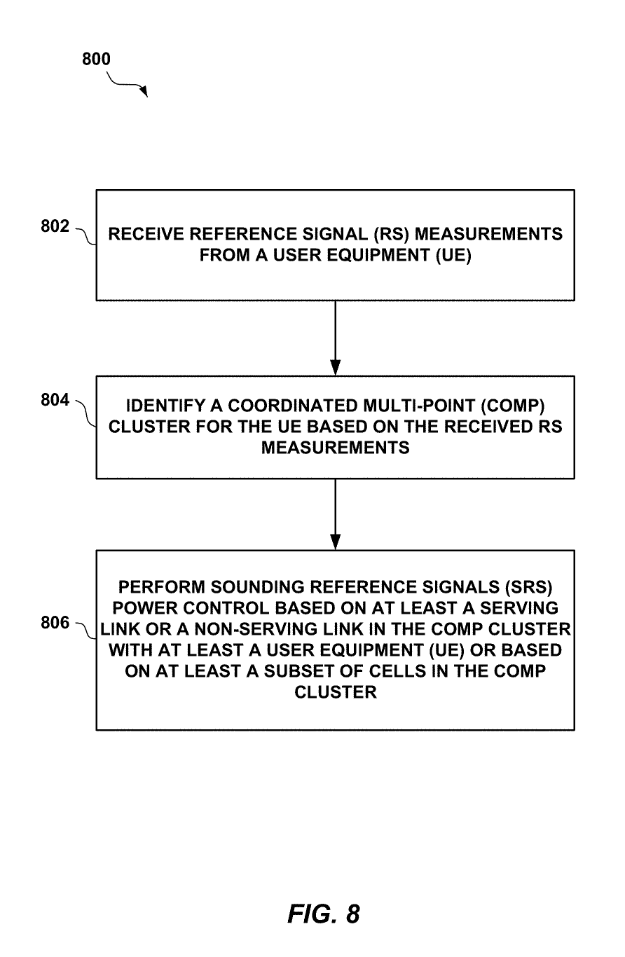

Referring to FIG. 8, in an operational aspect, a network entity such as network entity 14 or network entity 20 (FIG. 1) may perform one or more aspects of a method 800 for SRS power control management. For example, one or more of the processors 103, the memory 130, the modem 108, the transceiver 106 (including the receiver 32 and/or the transmitter 34), the CoMP management component 40, or at least one of the sub-components of the CoMP management component 40 may be configured to perform aspects of the method 800.

In an aspect, at block 802, the method 800 may include receiving RS measurements from a UE. In an aspect, for example, the CoMP management component 40, e.g., in conjunction with one or more of the processors 103, the memory 130, the modem 108, and/or the transceiver 106, may be configured to receive RS measurements, for example, RSRP measurement, RSRQ measurement, or an RSSI from one or more UEs.

In an aspect, at block 804, the method 800 may include identifying a CoMP cluster for the UE based on the received RS measurements. In an aspect, for example, the CoMP management component 40, e.g., in conjunction with one or more of the processors 103, the memory 130, the modem 108, and/or the transceiver 106, may be configured to identify one or more CoMP clusters for each UE based on the received RS measurements at block 802.

In an aspect, at block 806, the method 800 may include performing SRS power control based on at least a serving link or a non-serving link in the CoMP cluster with at least a UE or based on at least a subset of cells in the CoMP cluster. In an aspect, for example, the SRS power control component 44, e.g., in conjunction with one or more of the processors 103, the memory 130, the modem 108, and/or the transceiver 106, may be configured to perform SRS power control based on at least a serving link or a non-serving link in the CoMP cluster with at least a UE or based on at least a subset of cells in the CoMP cluster (e.g., the identified CoMP cluster at block 804).

Several aspects of a telecommunications system have been presented with reference to an LTE/LTE-A or a 5G communication system. As those skilled in the art will readily appreciate, various aspects described throughout this disclosure may be extended to other telecommunication systems, network architectures and communication standards.

By way of example, various aspects may be extended to other communication systems such as High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method of wireless communications, comprising:
transmitting, by a user equipment (UE), reference signal (RS) measurements for forming a coordinated multi-point (CoMP) cluster;
receiving, at the UE from at least a base station in the CoMP cluster, a message including information of at least a first cyclic prefix (CP) length for a first uplink transmission, wherein at least the first CP length for the first uplink transmission is different from a second CP length used for a second uplink transmission; and
transmitting, by the UE, the first uplink transmission using at least the first CP length.

2. The method of claim 1, wherein the first uplink transmission is associated with CoMP joint processing, and wherein the second uplink transmission is not associated with CoMP joint processing.

3. The method of claim 1, wherein at least the first CP length for the first uplink transmission is dynamically configured based on path loss difference or timing difference between the base station and another base station in the CoMP cluster.

4. The method of claim 1, wherein at least the first CP length is a normal CP length or an extended CP length, wherein the extended CP length is longer in time duration than the normal CP length.

5. The method of claim 1, wherein the first uplink transmission is a sounding reference signal (SRS) or a physical uplink signal.

6. The method of claim 1, wherein the first uplink transmission is an SRS, and wherein at least the first CP length for the SRS is configured along with a virtual cell identification (ID).

7. The method of claim 1, wherein the first uplink transmission is a physical uplink signal, and wherein the message is an uplink grant or a Radio Resource Control (RRC) message.

8. The method of claim 1, wherein the CoMP cluster includes at least the base station, and wherein the UE is connected to the CoMP cluster when a serving cell of the UE belongs to the CoMP cluster.

9. A method of wireless communications, comprising:
transmitting, by a user equipment (UE), reference signal (RS) measurements for forming a coordinated multi-point (CoMP) cluster;
receiving, at the UE from at least a base station in the CoMP cluster, a message including information of at least a cyclic prefix (CP) length for a downlink (DL) CoMP transmission, wherein at least the CP length for the DL CoMP transmission is different from the CP length for a single cell transmission; and
receiving, at the UE, the DL CoMP transmission with at least the CP length.

10. The method of claim 9, further comprising:
receiving, at the UE, one or more demodulation reference signal (DMRS) symbols based on at least the CP length.

11. The method of claim 9, wherein at least the CP length is a normal CP length or an extended CP length, wherein the extended CP length is longer in time duration than the normal CP length.

12. The method of claim 9, wherein the message includes information of a default CP length for the DL CoMP transmission.

13. The method of claim 9, wherein the message is a Radio Resource Control (RRC) message.

14. The method of claim 9, wherein the message includes a DL grant, and wherein the DL grant includes the information of at least the CP length.

15. The method of claim 9, wherein the message is received over a Physical Broadcast Channel (PBCH).

16. The method of claim 9, wherein the CoMP cluster includes at least the base station, and wherein the UE is connected to the CoMP cluster when a serving cell of the UE belongs to the CoMP cluster.

17. An apparatus for wireless communications, comprising:
a transmitter;
a receiver; and
at least one processor communicatively coupled to the transmitter and the receiver, wherein the at least one processor is configured to:
perform reference signal (RS) measurements;
transmit, via the transmitter, the RS measurements for forming a coordinated multi-point (CoMP) cluster;
receive, via the receiver from at least a base station in the CoMP cluster, a message including information of at least a first cyclic prefix (CP) length for a first uplink transmission, wherein at least the first CP length for the first uplink transmission is different from a second CP length used for a second uplink transmission; and
transmit, via the transmitter, the first uplink transmission using at least the first CP length.

18. The apparatus of claim 17, wherein the first uplink transmission is associated with CoMP joint processing, and wherein the second uplink transmission is not associated with CoMP joint processing.

19. The apparatus of claim 17, wherein at least the first CP length for the first uplink transmission is dynamically configured based on path loss difference or timing difference between the base station and another base station in the CoMP cluster.

20. The apparatus of claim 17, wherein at least the first CP length is a normal CP length or an extended CP length, wherein the extended CP length is longer in time duration than the normal CP length.

21. The apparatus of claim 17, wherein the first uplink transmission is a sounding reference signal (SRS) or a physical uplink signal.

22. The apparatus of claim 17, wherein the first uplink transmission is an SRS, and wherein at least the first CP length for the SRS is configured along with a virtual cell identification (ID).

23. The apparatus of claim 17, wherein the first uplink transmission is a physical uplink signal, and wherein the message is an uplink grant or a Radio Resource Control (RRC) message.

24. An apparatus for wireless communications, comprising:
a transmitter;
a receiver; and
at least one processor communicatively coupled to the transmitter and the receiver, wherein the at least one processor is configured to:
perform reference signal (RS) measurements;
transmit, via the transmitter, the RS measurements for forming a coordinated multi-point (CoMP) cluster;
receive, via the receiver from at least a base station in the CoMP cluster, a message including information of at least a cyclic prefix (CP) length for a downlink (DL) CoMP transmission, wherein the CP length for the DL CoMP transmission is different from the CP length for a single cell transmission; and
receive, via the receiver, the DL CoMP transmission with at least the CP length.

25. The apparatus of claim 24, wherein the at least one processor is configured to receive, via the receiver, one or more demodulation reference signal (DMRS) symbols based on at least the CP length.

26. The apparatus of claim 24, wherein at least the CP length is a normal CP length or an extended CP length, wherein the extended CP length is longer in time duration than the normal CP length.

27. The apparatus of claim 24, wherein the message includes information of a default CP length for the DL CoMP transmission.

28. The apparatus of claim 24, wherein the message is a Radio Resource Control (RRC) message.

29. The apparatus of claim 24, wherein the message includes a DL grant, and wherein the DL grant includes the information of at least the CP length.

30. The apparatus of claim 24, wherein the message is received over a Physical Broadcast Channel (PBCH).
